(19) United States
(12) Patent Application Publication
(10) Pub. No.: US 2014/0247245 A1
(43) Pub. Date: Sep. 4, 2014

(54) METHOD FOR TRIGGERING BUTTON ON THE KEYBOARD

(71) Applicant: SENTELIC TECHNOLOGY CO., LTD., Taipei City (TW)

(72) Inventor: Wen-Ting Lee, Taipei City (TW)

(21) Appl. No.: 14/056,934

(22) Filed: Oct. 17, 2013

(30) Foreign Application Priority Data
Oct. 17, 2012 (TW) 101138238

(51) Int. Cl. G06F 3/041; G06F 3/0488; G06F 3/044

(52) U.S. Cl. CPC G06F 3/0416; G06F 3/044; G06F 3/04886
USPC 345/174

(57) ABSTRACT

A method for triggering button is disclosed, which includes receiving a pressing signal that allows the keyboard to obtain a location information and a plurality of reference according to the pressing signal. A variation is calculated by the plurality of reference values and a button state is obtained according to a preset rule. When the button state is at a touch state, a prompt signal is sent to indicate the location information. When the button state is at a press-down state, the location information is to be determined. Thus, the different predetermined conditions can simulate at least three button states such as a touch state, a press-down state and a non-touch state of the traditional mechanical keyboard.

### FIELD OF THE INVENTION

The present invention relates to a trigging method, in particular to a method for trigging the button on the keyboard.

### BACKGROUND

A touch panel has been more popular as the progress of science and technology, especially for a capacitive touch panel. Generally, the location of the capacitance change on the capacitive touch panel is detected by the way of the capacitance induction, and then the location of capacitance value variation is transformed into the coordinate to obtain the location information of touch. Finally, the location information of touch is transformed into the actual touch location, for example, the letters on the button on the keyboard or click on the point of the mouse.

However, the capacitive touch panel is a smooth plane which is different from a traditional mechanical keyboard is that the capacitive touch panel will be induced when user touches the capacitive touch panel. As a result, user cannot continue to maintain the habits of using mechanism keyboard, such as user clicks the target location first and then presses down the key on the mechanism keyboard, however, user needs to observe the location on the keyboard before click. Accordingly, click the wrong location or click mistakenly on the mechanism keyboard would be often occurred.

In view of aforementioned, for the most application of the capacitive touch panel especially for the application of the capacitive touch keyboard, the common trigging method is that when the pressed location is to be detected, the information of the letter on the button of the pressed location is not sent immediately, the monitor will first display the letter information until the button is released, and then the information of the letter on the button of the final rest location on the keyboard is to be sent to display on the monitor. For example, when the user want to click on the letter “H” button on the keyboard, the user can trig any button location on the keyboard and arrest the button to slip to the actual location on the keyboard, such that the selection of wrong letter will not be occurred.

However, for the use of the traditional mechanical keyboard, especially for using finger for typing, the aforementioned method cannot be applied. For example, for the general skilled user, although only one finger is used to instantly click on the button which is to be pressed, but the remaining nine fingers are still placed on the preparation location corresponding to the button is to be pressed, and thus to compare with the typing by single finger, the aforementioned method can increase the typing speed.

Therefore, there is a need for an approach to provide a mechanism or a device to enable a capacitive touch panel to simulate the mechanical keyboard, and allowing the user touches the target location of the keyboard before press down the button to avoid the mistyping. Thus, the capacitive touch keyboard of the present invention can keep original advantages and can also simulate the advantage of the traditional mechanical keyboard.

### SOME EXEMPLARY EMBODIMENTS

According to above drawbacks in the conventional prior art, the applicant provides a method for trigging button of touch keyboard, which detects the button state by simulating at least three button states of the traditional mechanical keyboard, and three button states includes a touch state, a press-down state and a non-touch state.

The steps of the method for triggering button include receiving a pressing signal that allows the keyboard to obtain the location information and a plurality of reference values according to the pressing signal. A variation is calculated according to the plurality of reference values and a button state is determined according to a preset rule. When the button state is at a touch state, a prompt signal is sent to indicate the location information. In addition, when the button state is at a press-down state, the location information is sent.

According to one embodiment of the present invention, a method for triggering button applied for the capacitive touch keyboard includes receiving a pressing signal that allows the capacitive touch keyboard to obtain a location information and a plurality of capacitance values according to the pressing signal. A capacitance value variation is calculated according to the capacitance values to determine a button state. When the button state is at a touch state, and then a prompt signal is sent. In addition, when the key state is at a press-down state, and then the location information is to be sent.

According to another embodiment of the present invention, a method for triggering button applied for shielding touch keyboard includes receiving a pressing signal that allows the shielding touch keyboard obtains a location information and a plurality of area values according to the pressing signal. An area variation is calculated according to the plurality of area values to determine a button state. When the button state is at a touch state, a prompt signal is sent to indicate the location information. In addition, when the button state is at press-down state and the location information is to be sent.

Thus, according to aforementioned, the present invention divides the button state into a touch state, a press-down state and a non-touch respectively according to the reference value setting and the variation, so as to simulate the habit of touching the target location and then pressing-down for using of traditional mechanical keyboard.

### BRIEF DESCRIPTION OF THE DRAWINGS

The disclosure is illustrated by way of example, and not by way of limitation, in the figures of the accompanying drawings in which like reference numerals refer to similar elements and in which:

FIG. 1 shows an embodiment of the flow process of triggering method of keyboard in accordance with the present invention disclosed herein;

FIG. 2 shows an embodiment of a waveform diagram corresponding to capacitance value variation of FIG. 1 in accordance with the present invention disclosed herein;

FIG. 3 shows an embodiment of a flow process of step S12 of FIG. 1 in accordance with the present invention disclosed herein;

FIG. 4 shows another embodiment of a flow process of step S12 of FIG. 1 in accordance with the present invention disclosed herein;

FIG. 5 show an embodiment of a waveform diagram corresponding to capacitance values of FIG. 4 in accordance with the present invention disclosed herein;

FIG. 6 shows another embodiment of triggering method of the keyboard in accordance with the present invention disclosed herein; and

FIG. 7 shows an embodiment of a flow process of step S22 of FIG. 6 in accordance with the present invention disclosed herein.

### DESCRIPTION OF THE PREFERRED EMBODIMENT

The embodiments of the apparatus and/or methods are disclosed. In the following description, for purposes of explanation, numerous specific details are set forth in order to provide a thorough understanding of the embodiments of the invention. It is apparent, however, to one skilled in the art that the present invention may be practiced without these specific details or with an equivalent arrangement.

The embodiments of the present disclosure are able to apply for different kinds of keyboard to simulate at least three button states of the traditional mechanical keyboard such as a touch state, a press-down state and a non-touch state.

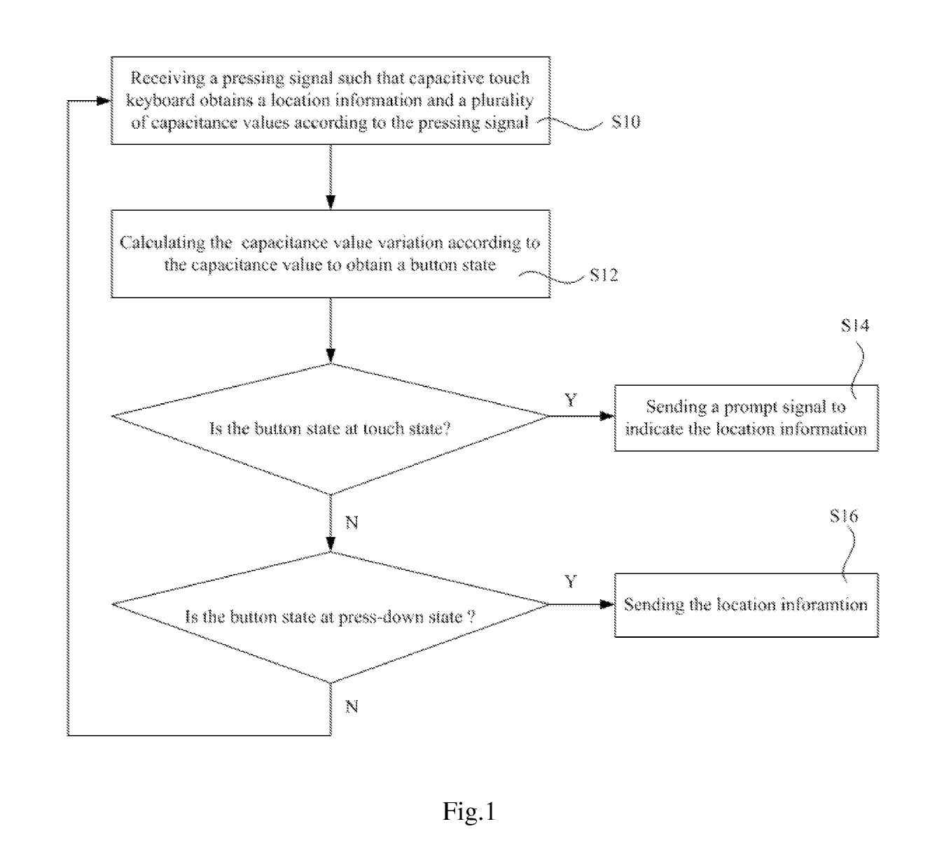

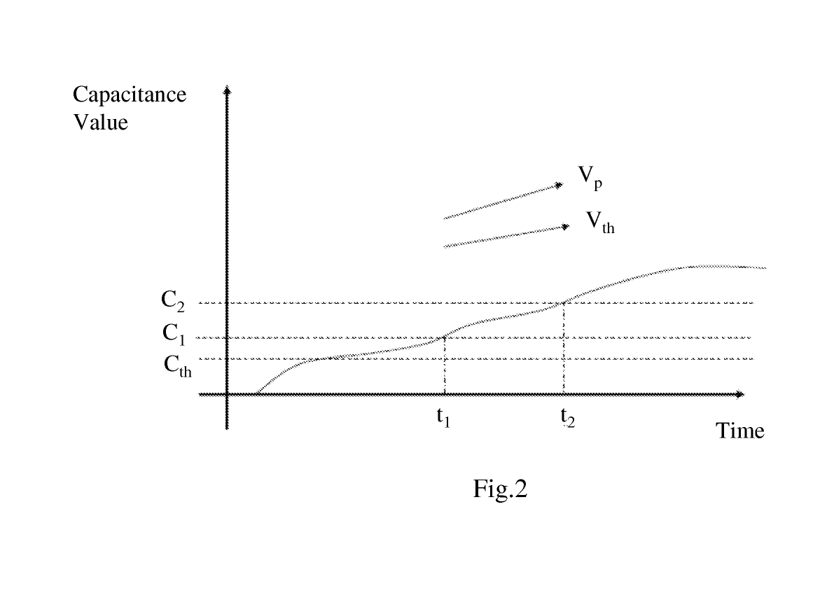

Please refer to FIG. 1 and FIG. 2. FIG. 1 is a flow process of the triggering method of one embodiment of the present invention. FIG. 2 is a schematic view of waveform diagram of the capacitance value variation corresponding to FIG. 1. In this embodiment, the triggering method applied for a capacitive touch keyboard includes a step S10 denotes receiving a pressing signal that allows the capacitive to obtain a location information and a plurality of capacitance values according to the pressing signal. Step S12 denotes that the capacitance value variation according to the capacitance values to determine a button state. Step S14 denotes that when the button state is at touch state, a prompt signal is sent to indicate the button location. Step S16 denotes that when the button state is at a press-down state, the touch location information is sent.

When the user touches the capacitive touch keyboard, the capacitance induction is induced by the way of user touches the capacitive touch keyboard and the touch location is further to be obtained. As described in step S10, the capacitive touch keyboard obtains the touch location information corresponding to the capacitance value which is induced by the capacitance induction, in which the touch location information is corresponding to the button location.

However, in order to reduce the pressing wrong button or the system operation loading, in general, a touch threshold value Cth is preset for the capacitive touch keyboard. When the capacitance value is smaller than the touch threshold value Cth, the capacitance value will be regards as a noise signal or is to be omitted. Thus, the button state is determined as the non-touch state. In other words, the capacitance value is higher than the touch threshold value Cth that will be regards as the effective pressing or touching. Thus, the capacitance value corresponds to the pressing signal as step S10 which is at least larger than or equal to the touch threshold value Cth corresponding to the pressing signal in step S10. The preset touch threshold value Cth is the skilled art in this invention, the setting value of the touch threshold value Cth is depends upon the balance between the accuracy and the sensitivity, that is, the touch threshold value Cth is higher, and the accuracy is higher. In contrast, the touch threshold value Cth is lower, and the sensitivity is higher.

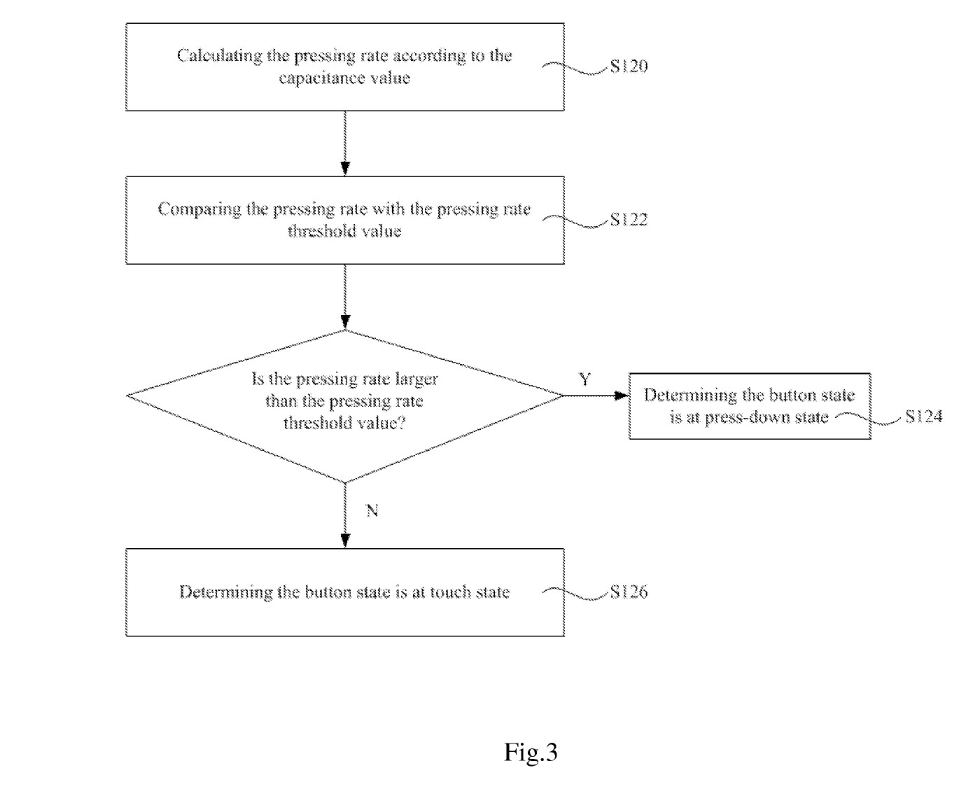

Please refer FIG. 2 and FIG. 3. FIG. 3 shows the flow process of step S12 in FIG. 1. In one embodiment, step 12 determines the button state which depends on the pressing button rate (or touching button rate). Step 12 also includes step S120 denotes that a pressing rate value Vp is calculated according to the capacitance values. Step S122 denotes that the pressing rate value Vp is compared with the pressing rate threshold value Vth. Step S124 denotes that when the pressing rate value Vp is larger than the pressing rate threshold value Vth, the button state is determined as a press-down state. Step S126 denotes that when the pressing rate value Vp is smaller than the pressing rate threshold value Vth, the button state is determined as a touch state.

In order to simulate the button state of the traditional mechanical keyboard, the user can find out the desired button location (for example, the letter location) and then press down the button. By the capacitance value is proportional to the touching area, with the user pressing and pushing the button, the touching area between the user's finger and the button so as to increase the capacitance value of the induction capacitance. Thus, the press-down rate can be determined by the capacitance value variation.

Briefly, as shown in FIG. 2, for the first time t1 and the second time t2 in the time segment, the slope of the curve of capacitance value variation is larger than the preset slope, that is, the pressing rate value Vp is larger than the preset pressing rate threshold value Vth, accordingly, the pressing rate value Vp can be expressed by following relationship:

$${V}_{p} = \frac{Δ C}{Δ T} = \frac{{c}_{2} - {c}_{1}}{{t}_{2} - {t}_{1}} ,$$

wherein C1 is capacitance value at time t1, C2 is capacitance value at time t2, ΔTis time zone and ΔC is capacitance value variation.

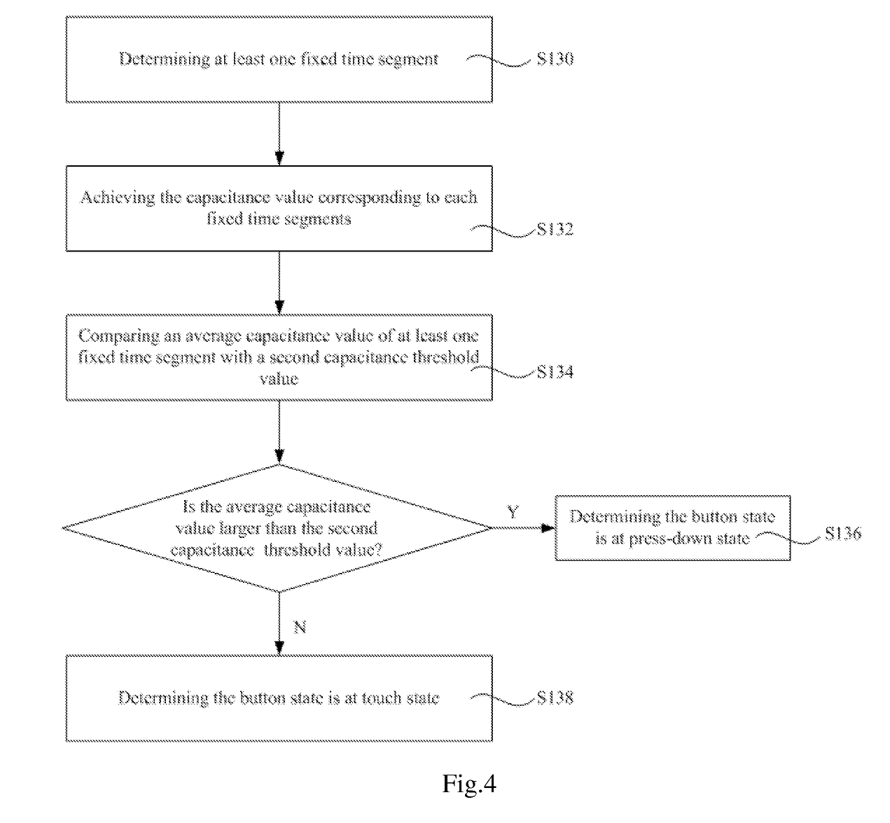

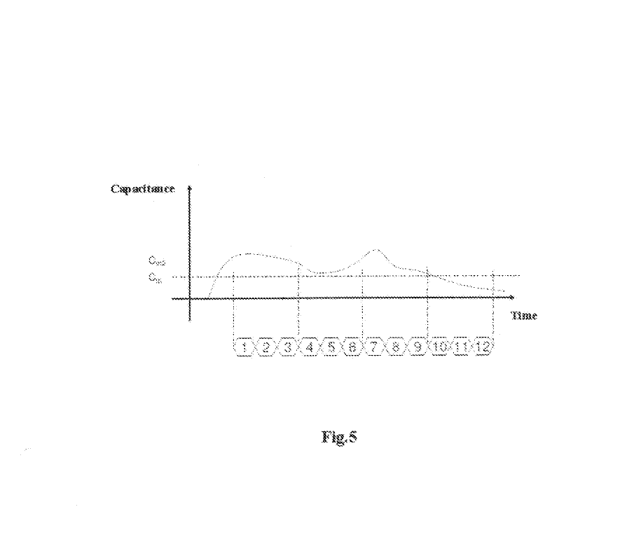

In addition, the button state is determined by the way of the pressing rate. Please refer to FIG. 4 and FIG. 5. FIG. 4 is another embodiment of flow process of step S12 in FIG. 1. FIG. 5 is a waveform diagram of an embodiment corresponding to the capacitance value variation in FIG. 4.

In step S12, the fixed time interval can be set to determine the capacitance value to determine the button state. In another embodiment, the step S12 includes step S130 denotes that at least one fixed time segment is set. Step S132 denotes that capacitance value corresponding to each fixed time segment is achieved. Step S134 denotes that an average capacitance value of at least fixed time segment compared with the second capacitance threshold value Cth2. Step S136 denotes that when the average capacitance value is larger than the second capacitance threshold value Cth2, the button state is determined as a press-down state. Step S138 denotes that when the average capacitance value is smaller than the second capacitance threshold value Cth2, the button state is determined as touch state.

In Step S134, the capacitance value is set as a fixed time segment, the average capacitance value is the capacitance value of the fixed time segment. Similarly, the capacitance values are obtained by the plurality of fixed time segments, the average capacitance value equals to the total capacitance values divided by the number of the fixed time segments.

For example, three time segments is set as a unit, and the average capacitance value of the three time segments is larger than the second capacitance threshold value Cth2. As shown in FIG. 5, the first time segment, the second time segment, and the third segment are press-down state. The fourth time segment, fifth time segment, and the sixth time segment are touch state. The seventh time segment, eighth time segment, and ninth time segment are press-down state. Although the capacitance value of the eighth time segment and ninth time segment are lower than the second capacitance threshold value Cth2, the seventh time segment, average capacitance value of the eighth time segment and ninth time segment are still larger than the second capacitance threshold value Cth2, and thus the button is determined as a press-down state. In addition, the capacitance value of the tenth time segment, the eleventh time segment and the twelfth time segment are lower than the touch threshold value Cth respectively, which is not an effective touch, and thus the button state is determined as a non-touch state.

Thus, according to step S10 and step S12, the triggering capacitive touch keyboard of the present invention can simulate the three button states such as a touch state, a press-down state and a non-touch state of the traditional mechanical keyboard.

Because of the capacitive touch keyboard is not manufactured in the traditional mechanical keyboard, and each button is capable of bounce or each button includes the interval therebetween. Thus, user can know that the current position where the finger stays on. Accordingly, step S14 informs the information of current finger position for user.

For example, when the button state is at touch state, the letter on the button can show on the display such that user does not need to look at the finer pressing position by using the capacitive touch keyboard to avoid the inadvertently touching to generate the wrong letter.

Accordingly, the types of the prompt signal may be a single signal or the combination of the signals and the prompt signal can be an image, audio, voice, or vibration. The location information is cooperated with different types or the combinations of above signals. For example, when the user touches the letter button “A” on the keyboard, and thus the letter button “A” can be read via the voice, such that the user does not need to look at the keyboard for typing.

It is note that when the prompt signal is voice, audio or vibration which can benefit the visually impaired user to enhance ease of use. Because the most of the visually impaired are familiar with Braille text symbols, in order not to change their original typing habits and the visually impaired user brailles through the contact surface of the capacitive touch keyboard which is unable to reach the efficacy by the way of using capacitive touch keyboard currently.

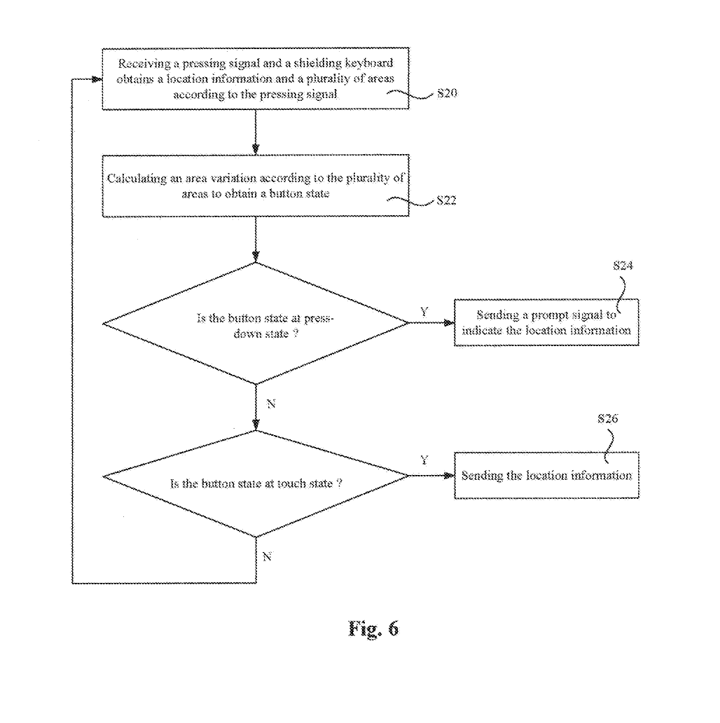

Please refer to FIG. 6. FIG. 6 shows another embodiment of the flow process of the triggering method of the keyboard of the present invention. The principle or the concept is similar to the above embodiment and the different is that the capacitive touch keyboard of this embodiment can apply for the shielding keyboard (such as projection keyboard). The shielding keyboard trigs the button by using the finger to shield the area of the button of the keyboard, such that the shielding keyboard can also simulate the three button states of the traditional mechanical keyboard such as a touch state, a press-down state and a non-touch state according to the different between the area of the fingertip (touch) and the area of the finger pulp.

In this embodiment, the triggering method includes step S20 denotes that receiving a pressing signal, such that a location information and a plurality of areas can be obtained according to the pressing signal. Step S22 denotes that an area variation is calculated according to the plurality of areas to obtain a prompt signal. Step S24 denotes that when the button state is at touch state, a prompt signal is sent to indicate the location information. Step S26 denotes that when the button state is at press-down state, the location information is sent.

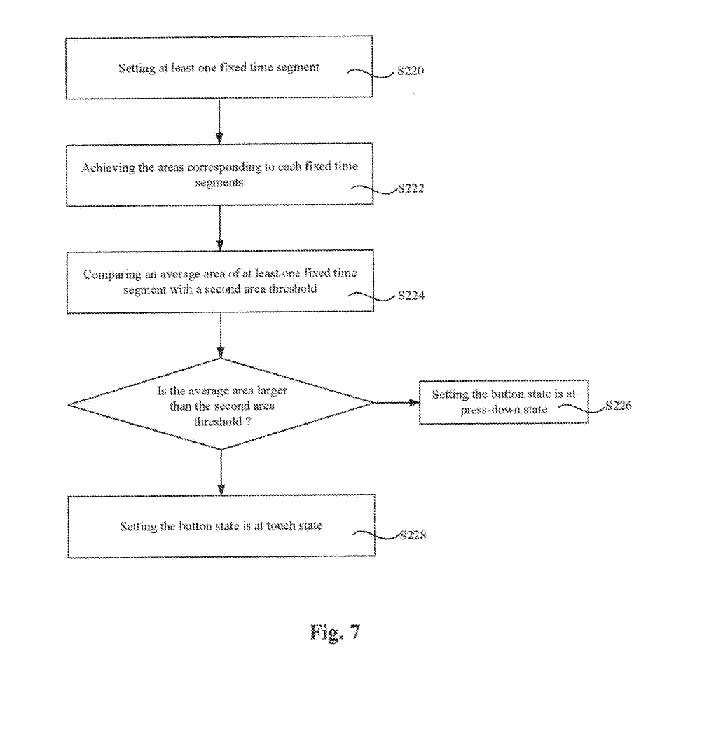

Another embodiment similar to above capacitive touch keyboard is touching area threshold value denoted as step S20. When the received area is smaller than the touching area threshold, the received area will regards as the noise signal or is to be omitted directly and thus this button state is determined as a non-touch state. Please refer to FIG. 6 and FIG. 7. FIG. 7 is the flow process of the step 22 of FIG. 6. According to this embodiment, step S22 includes step S220 denotes that at least one fixed time segment is set. Step S222 denotes that the area is corresponding to each fixed time segment which is achieved. Step S224 denotes that an average area of at least one fixed time segment is compared with a second area threshold. Step S226 denotes that when the average area is larger than the second area threshold, the button state is determined as a press-down state. Step S228 denotes that when the average area is smaller than the second area threshold, the button state is determined as a touch state.

When the obtained area is a single fixed time segment in step S228 and the average capacitance value can regards as the corresponded area value. Similarly, when the area is obtained from the plurality of fixed time segments, the average area equals to the total shielding area divided the number of the fixed time segments. In addition, the step S24 and step S26 are similar to above step S14 and step S16, and thus it is not to be described herein.

Thus, according to above embodiment, the button state of the keyboard can determined as the touch state, a press-down state and non-touch state via the reference value for the triggering method of the keyboard of the present invention.

Accordingly, the capacitive touch keyboard or shielding keyboard can simulate the habits of the traditional mechanical keyboard such as the user touches the target location and then press down the button on the keyboard.

While the invention has been described in connection with a number of embodiments and implementations, the invention is not so limited but covers various obvious modifications and equivalent arrangements, which fall within the purview of the appended claims. Although features of the invention are expressed in certain combination among the claims, it is contemplated that these features can be arranged in any combination and order.

What is claim is:

1. A method for triggering keystrokes, comprising:
receiving a pressing signal that allows a keyboard to obtain a location information and a plurality of reference values according to said pressing signal;
calculating a variation according to said plurality of reference values;
determining a button state according to a preset rule;
sending a prompt signal to indicate said location information when said button state is at a touch state; and
sending said location information when said button state is at a press-down state.

2. A method for triggering button applied for a capacitive touch keyboard, comprising:
receiving a pressing signal so as to said capacitive touch keyboard receives a location information and a plurality of capacitance values according to said pressing signal;
calculating a capacitance value variation according to said plurality of capacitance values to determine a button state;
sending a prompt signal to indicate said location information when said button state is at a touch state; and
sending said location information when said button state is at a press-down state.

3. The method as claimed in claim 2, wherein calculating said capacitance value variation according to said plurality of capacitance values to determine said button state comprises:
calculating a pressing rate according to said plurality of capacitance values;
comparing said pressing rate with a pressing threshold rate;
setting said button state is at said press-down state when said pressing rate value is larger than said pressing threshold rate value; and
setting said button state is at said touch state when said pressing rate value is smaller said pressing threshold rate value.

4. The method as claimed in claim 3, wherein the pressing rate is calculated by the following formula:
$${V}_{p} = \frac{Δ C}{Δ T} = \frac{{c}_{2} - {c}_{1}}{{t}_{2} - {t}_{1}} ,$$
wherein
V_{P} is pressing rate value, t₁ is first time point, t₂ is second time point, C₁ is a capacitance value at t₁, C₂ is a capacitance value at t₂, ΔT is a time period and ΔC is a capacitance value variation.

5. The method as claimed in claim 2, wherein calculating said capacitance value variation according to said plurality of capacitance values to determine said button state comprises:
setting at least one fixed time segment;
obtaining a capacitance value corresponding to said fixed time segment;
comparing an average capacitance value of said fixed time segment with a second capacitance value threshold;
determining said button state is at said press state when said average capacitance value is larger than said second capacitance threshold value; and
setting said button state is at said touch state when said average capacitance value is smaller than said second capacitance threshold value.

6. The method as claimed in claim 5, wherein said average capacitance value is calculated by the total capacitance value of said fixed time segment divided the number of said fixed time segment.

7. The method as claimed in claim 2, wherein the device of the capacitive touch keyboard with a Braille structure function for a visually impaired user.

8. The method as claimed in claim 1, wherein said prompt signal is video signal, audio signal, voice signal or vibration signal.

9. A method for triggering button applied for a shielding touch keyboard, comprising:
receiving a pressing signal so as to said shielding touch keyboard receives a location information and a plurality of area values according to said pressing signal;
calculating an area variation according to said plurality of area values to determine a button state;
sending a prompt signal to indicate said location information when said button state is at a touch state; and
sending said location information when said button state is at a press-down state.

10. The method as claimed in claim 9, wherein calculating said area variation according to said plurality of areas to determine said key state comprises:
setting at least one fixed time segment;
obtaining an area value corresponding to each said fixed time segments;
comparing an average area of said at least one fixed time segment with a second area threshold;
determining said button state is at said press-down state when said average area is larger than said second area threshold; and
determining said button state is at said touch state when said average area is smaller than said second area threshold.
